(19) United States
(12) Patent Application Publication
(10) Pub. No.: US 2020/0304248 A1
(43) Pub. Date: Sep. 24, 2020

(54) FEEDBACK TIMING

(71) Applicant: Nokia Technologies Oy, Espoo (FI)

(72) Inventors: Timo Lunttila, Espoo (FI); Esa Tiirola, Kempele (FI); Klaus Hugl, Wien (AT); Kari Hooli, Oulu (FI)

(21) Appl. No.: 16/088,138

(22) PCT Filed: Jan. 30, 2017
(86) PCT No.: PCT/FI2017/050050

§ 371 Date: Sep. 25, 2018

Related U.S. Application Data
(60) Provisional application No. 62/316,285, filed on Mar. 31, 2016.

(51) Int. Cl. H04L 1/18

(52) U.S. Cl. CPC H04L 1/1854; H04L 1/1864

(57) ABSTRACT

There is provided a method, comprising: detecting (200) that data from a transmitting device is scheduled to the apparatus; determining (210) a transmission time interval length applied in the transmission of the scheduled data to the apparatus; and selecting (220), at least partially based on the determined transmission time interval length, an acknowledgement feedback mode to be used for sending acknowledgment feedback for the scheduled data amongst a plurality of acknowledgement feed-back modes, wherein the selected acknowledgement feedback mode defines acknowledgement feedback timing.

### FIELD OF THE INVENTION

The invention relates generally to acknowledgement feedback timing in connection of varying transmission time interval lengths.

### BACKGROUND

It is expected that latency needs to be reduced in future communications. One means for reaching this may comprise application of short/shortened transmission time intervals (sTTI). However, use of such may cause problematic situations in terms of acknowledgement feedback signalling and scheduling. Therefore, there is a need to provide a solution for dynamic switching between legacy TTIs and sTTIs, and for acknowledgement feedback thereto with minimal impact on scheduling.

### BRIEF DESCRIPTION OF THE INVENTION

The invention is defined by the independent claims.

Some embodiments of the invention are defined in the dependent claims.

### LIST OF THE DRAWINGS

In the following, the invention will be described in greater detail with reference to the embodiments and the accompanying drawings, in which

FIG. 1 presents an example communication scenario to which embodiments are applicable to;

FIGS. 2 and 7 show methods, according to some embodiments;

FIGS. 3A, 3B, and 3C show example of feedback modes, according to some embodiments;

FIG. 4 illustrates an example flow diagram for the selection of the feedback mode, according to some embodiments;

FIG. 5 depicts dynamic switching between feedback modes, according to some embodiments;

FIG. 6 illustrates an example of feedback collision, according to an embodiment; and

FIGS. 8 and 9 show apparatuses, according to some embodiments.

### DESCRIPTION OF EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Embodiments described may be implemented in a radio system, such as in at least one of the following: Universal Mobile Telecommunication System (UMTS, 3G) based on basic wideband-code division multiple access (W-CDMA), high-speed packet access (HSPA), Long Term Evolution (LTE), LTE-Advanced, LTE-Advanced Pro, and/or 5G system.

The embodiments are not, however, restricted to the system given as an example but a person skilled in the art may apply the solution to other communication systems provided with necessary properties. One example of a suitable communications system is the 5G system, as listed above. 5G has been envisaged to use multiple-input-multiple-output (MIMO) multi-antenna transmission techniques, more base stations or nodes than the current network deployments of LTE (a so-called small cell concept), including macro sites operating in co-operation with smaller local area access nodes and perhaps also employing a variety of radio technologies for better coverage and enhanced data rates. 5G will likely be comprised of more than one radio access technology (RAT), each optimized for certain use cases and/or spectrum. 5G mobile communications will have a wider range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or cloud data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent. Some other technology advancements probably to be used are Software-Defined Networking (SDN), Big Data, and all-IP, which may change the way networks are being constructed and managed.

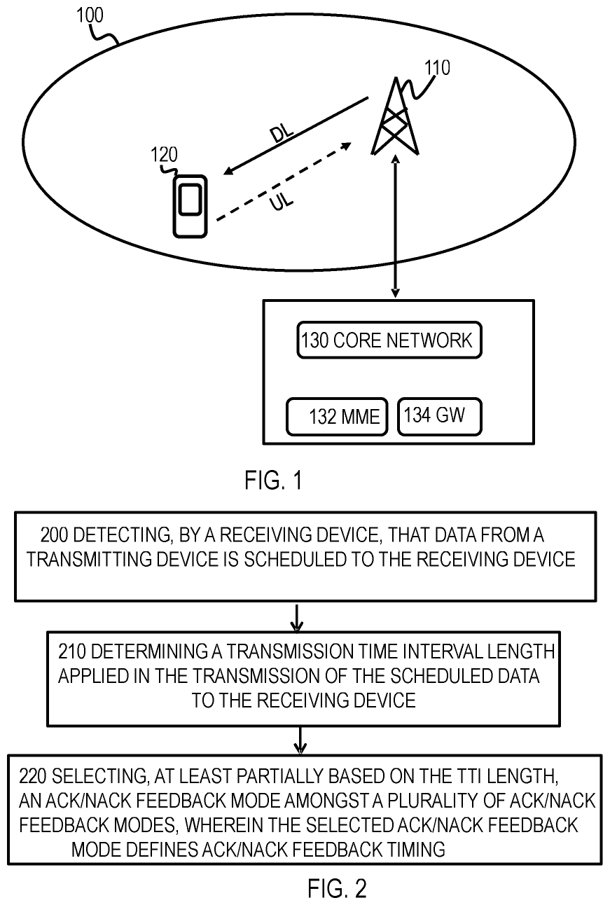

FIG. 1 illustrates an example of a communication system to which embodiments of the invention may be applied. The system may comprise an access node 110 providing a cell 100. Each cell may be, e.g., a macro cell, a micro cell, femto, or a pico cell, for example. In another point of view, the cell may define a coverage area or a service area of the access node 110. The network node 110 may be an evolved Node B (eNB) as in the LTE and LTE-A, an access point of an IEEE 802.11-based network (Wi-Fi or wireless local area network, WLAN), or any other apparatus capable of controlling radio communication and managing radio resources within a cell. For 5G solutions, the implementation may be similar to LTE-A, as described above. The access node 110 may be called a base station or a network node. The system may be a cellular communication system composed of a radio access network of access nodes, each controlling a respective cell or cells. The access node 110 may provide user equipment (UE) 120 with wireless access to other networks such as the Internet. The wireless access may comprise downlink (DL) communication from the eNB 110 to the UE 120 and uplink (UL) communication from the UE 120 to the eNB 110. Additionally, one or more local area access nodes may be arranged within a control area of a macro cell access node. The local area access node may provide wireless access within a sub-cell that may be comprised within a macro cell. Examples of the sub-cell may include a micro, pico and/or femto cell. Typically, the sub-cell provides a hot spot within a macro cell. The operation of the local area access node may be controlled by an access node under whose control area the sub-cell is provided.

In the case of multiple access nodes in the communication network, the access nodes may be connected to each other with an interface. LTE specifications call such an interface as X2 interface. In IEEE 802.11 networks, a similar interface is provided between access points. Other communication methods between the access nodes may also be possible. The access node may be further connected via another interface to a core network 130 of the cellular communication system. The LTE specifications specify the core network as an evolved packet core (EPC), and the core network may comprise a mobility management entity (MME) 132 and a gateway node 134. The MME may handle mobility of terminal devices in a tracking area encompassing a plurality of cells and also handle signalling connections between the terminal devices and the core network 130. The gateway node 134 may handle data routing in the core network 130 and to/from the terminal devices.

As said in the background part, there may be need to reduce latency in future communication systems. One way to reach this may be to use short transmission time intervals (sTTI) and reduced processing times. The TTI is a parameter related to encapsulation of data from higher layers into frames for transmission on the radio link layer. TTI refers to the duration of a transmission on the radio link. The TTI is related to the size of the data blocks passed from the higher network layers to the radio link layer. In the terminology of this application, a sTTI may be short (or at least shorter) compared to current Release's TTI (i.e. legacy TTI), which corresponds to 1 millisecond (ms), i.e. one subframe. The sTTI for LTE may be e.g. 1, 2, 3, . . . , 6/7 symbols, depending on whether a long or a normal cyclic prefix (CP) is applied. Consequently, it is important to assess specification impact and performance of TTI lengths between slot length (6/7 symbols=0.5 ms) and one modulation symbol (for LTE downlink orthogonal frequency division multiplexing (OFDM) symbols, for LTE uplink single carrier frequency division multiplexing (SCFDM) symbols), taking into account impact on reference signals and physical layer signalling. It is expected that the UE 120 is supposed to be able to receive a physical downlink shared channel (PDSCH) applying the legacy (1 ms) TTI length and a shortened PDSCH (sPDSCH) applying the sTTI length, meaning that switching between a sTTI and legacy TTI length needs to be supported.

One aspect to consider is that in the DL side it may be needed that the eNB 110 schedules data for the UE 120 using either the legacy TTI or a short/shortened TTI in different subframes, i.e. support dynamic switching between the legacy TTI and a shortened TTI. This may be needed, since the cell coverage with a shortened TTI tends to be inherently worse than that of 1 ms TTI at least for the UL. In case e.g. a UE configured with sTTI is moving towards the cell edge, there will be a need to switch to using a full 1 ms TTI at some point in time to preserve UL coverage. Furthermore, with short TTIs the signalling overhead is likely larger as at least some control information is needed for each sTTI. Moreover, the demodulation reference signal overhead may be increasing as at least some reference signals need to be transmitted with the shortened TTI data operation. To mitigate signalling and reference signal overhead increase, it can be beneficial to use short TTI only when low latency is needed and the 1-ms TTI otherwise. Scheduling of sTTI can also occasionally lead to inefficient overall scheduling as even a single sTTI allocation reserves full 1 ms PRBs from legacy UE perspective, limiting the scheduling possibilities for legacy UEs. Therefore one key design criteria for sTTI operation is to enable fully dynamic switching between the sTTI and the legacy TTI with no or minimal scheduling restrictions.

One signalling possibly affected by the use of sTTI is acknowledgement feedback signalling. Acknowledgement feedback signalling may refer to medium access control (MAC) layer hybrid automatic repeat request (HARM) process, which requires the receiving device (e.g. the UE 120) to send a positive acknowledgment (ACK) or a negative acknowledgment (NACK) to the transmitter (e.g. the eNB 110) of the data that is to be ACK/NACKed. This is called HARQ-ACK in general in the following.

It is also expected that different TTI lengths for DL and UL are possible. One scenario is that sTTI is applied for the DL (sPDSCH) whereas for UL physical uplink shared channel (PUSCH) a legacy TTI is used to preserve coverage. On the other hand, to obtain benefits from lower latency in the DL side, the latency of the corresponding HARQACK feedback (carried in the uplink on either physical uplink control channel (PUCCH) or PUSCH) could be shortened as well.

Currently LTE applies fixed/predetermined HARQ-ACK timing. Consequently, in a frequency division duplexing (FDD) mode, HARQ-ACK is transmitted in uplink in a subframe # n+4 for a PDSCH transmitted in downlink in subframe # n. For time division duplexing (TDD) mode, HARQ-ACK timing depends on the TDD UL-DL configuration and subframe number according to a predefined DL association set index table, the minimum HARQ-ACK delay being four subframes. In addition to that, LTE applies fixed TTI length in DL. This creates at maximum one HARQ-ACK feedback, possibly containing multiple HARQ-ACK bits, per subframe (1 ms) in UL direction.

Therefore, a solution is needed for an acknowledgement feedback scenario where the TTI length in DL and/or the TTI length for the acknowledgment feedback in UL may vary dynamically. Note that the terms “TTI” and “TTI length” are used interchangeably.

FIG. 2 depicts a method which may be performed by a receiving radio device, such as the UE 120, to at least partially address the above mentioned issues. The proposal includes introduction of different HARQ-ACK feedback modes/timings for latency reduction such that the limitations to the eNB's 110 scheduling are minimized as well as means for switching between the modes. It should be understood that while the description assumes the UE 120 is the receiver/receiving device and the eNB 110 is the sender/transmitting device of the data that is to be ACK/NACKed, the solution is applicable to other communicating parties as well, such as to device-to-device (D2D) communication between two UEs or to UL data transmission where eNB ACK/NACKs the UL data transmission or to relying between two eNBs. Other accompanying Figures may provide further embodiments by describing the method of FIG. 2 in details.

In block 200, the UE 120 detects that data from the eNB 110 is scheduled to the UE 120. The scheduled data may be detected by reception of scheduling information. The scheduling information may be carried on a control information element on a downlink channel, such as on a physical downlink control channel (PDCCH) or PDSCH (or evolved PDCCH, ePDCCH or ePDSCH), addressed to the UE 120 and indicating that the UE 120 has a downlink grant in one or more DL subframes.

In block 210 the UE 120 determines the TTI applied in the transmission of the scheduled data to the UE 120. The TTI length may refer to the TTI length used by the PDCSH transport block(s) carrying the DL data to the UE 120. The DL TTI used for the data may be determined from the scheduling information including the downlink control channel (e.g. PDCCH, ePDCCH, PDSCH, ePDSCH) the scheduling information is carried. For example, the scheduling information may carry an indication that the DL data will be transferred to the UE 120 in one or more shortened TTIs. Thus, the TTI length can be derived from the scheduling info, or from the reception of the DL data on PDSCH. Alternatively, the downlink grants for different TTI lengths might be at least partially carried on different downlink control channels present with periodicity given by the sTTI length in order to enable instant sPDSCH scheduling for each sTTI. In one embodiment the UE 120 may detect that the DL data is to-be-transmitted using the legacy TTI. In another embodiment, the UE 120 may detect that the DL data is to-be-transmitted using the sTTI.

In block 220, the UE 120 selects, based at least partially on the determined TTI, an acknowledgement feedback mode of operation, amongst a plurality of acknowledgement feedback modes, for sending ACK/NACK for the scheduled data. The plurality of acknowledgement feedback modes may differ e.g. in the lengths of the TTI used for the DL data and the TTI used for the acknowledgement feedback. Therefore, the selected HARQ-ACK mode may define the timing (e.g. TTI and the time instant) for sending the HARQ-ACK to the eNB 110. With different timings, the ACK/NACK is sent at a different time instant to the eNB 110. One acknowledgment timing may provide shorter HARQ-ACK processing while another acknowledgment timing may provide a longer (or legacy) HARQ-ACK processing. Thus, the selected mode/timing may further define the upper limit for processing delay of the HARQ operation. The UE 120 may then send the ACK/NACK feedback according to the selected mode to the eNB 110 e.g. on PUCCH or PUSCH. Accordingly the eNB 110 may then receive the ACK/NACK from the UE 120.

Let us assume the UE 120 is configured to low latency operation (i.e. it is not a legacy UE incapable of operating sTTIs). In such case, the UE 120 may determine the HARQ-ACK feedback timing as well as the PUCCH format (legacy 1 ms vs. shortened PUCCH) for the HARQ-ACK depending on the selected mode, i.e. at least partially depending on the TTI of the scheduled DL data. The UE 120 may select the mode under the control of the eNB 110. The eNB 110 may control the mode selection/configuration by use of a certain scheduling configuration/characteristics, such as certain TTI length, use of a certain control channel type, use of a certain control information format and/or explicit indications, for example, as will be described below.

In one embodiment, the UE 120 may detect scheduling information from the eNB 110, the scheduling information indicating scheduled data transmission to the UE 120. Then the UE 120 may select, at least partially based on the scheduling information, the acknowledgement feedback mode to be used for sending ACK/NACK feedback for the scheduled data amongst a plurality of acknowledgement feedback modes. The selected acknowledgement feedback mode may define at least one of the following: the acknowledgement feedback timing and a control channel type/format used for the ACK/NACK (e.g. the PUCCH type/format).

There may be e.g. three different HARQ-ACK feedback modes defined, and the UE 120 is to selects one of those. Each feedback mode may be associated with a specific feedback timing. Let us look at some of the plurality of modes more closely.

One mode may be called a fall-back mode. Here legacy DL transport block(s) carrying the DL data to the UE 120 are used. The legacy DL transport blocks may use 1 ms TTI(s). In this mode the HARQ-ACK feedback for this legacy DL data received in subframe # n is transmitted using the legacy PUCCH in UL subframe # n+4, or later. The term “later” may refer to TDD mode of operation, where, depending on the UL/DL configuration, the feedback may come later than in subframe # n+4. In this fall-back mode, the timing and the HARQ-ACK channel may follow the legacy configuration, e.g. the TTI length used for the uplink ACK/NACK is the legacy TTI. As throughout the application, the legacy TTI may refer to 1 ms TTI, for example. This mode may provide robust coverage and fully predictable operation, e.g. during RRC reconfiguration when low-latency operation is enabled, disabled, or reconfigured.

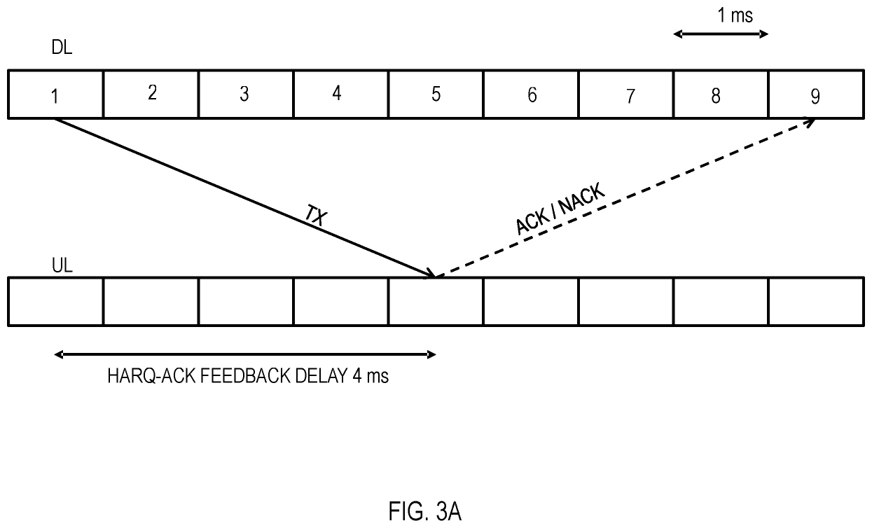

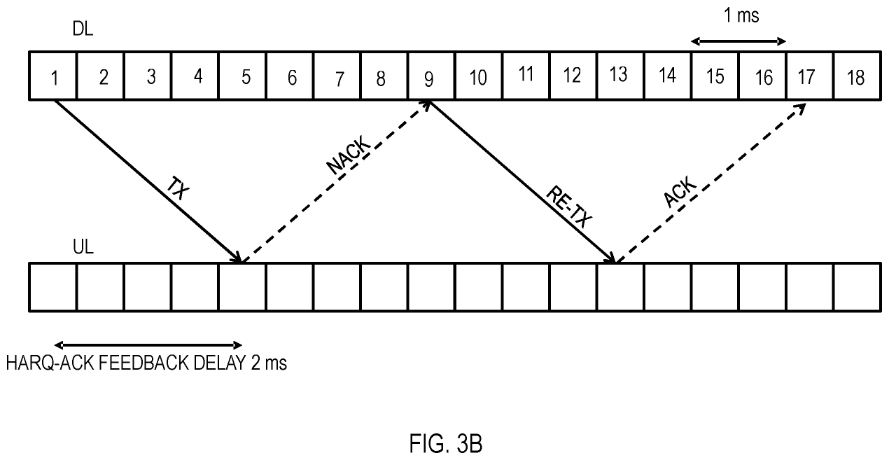

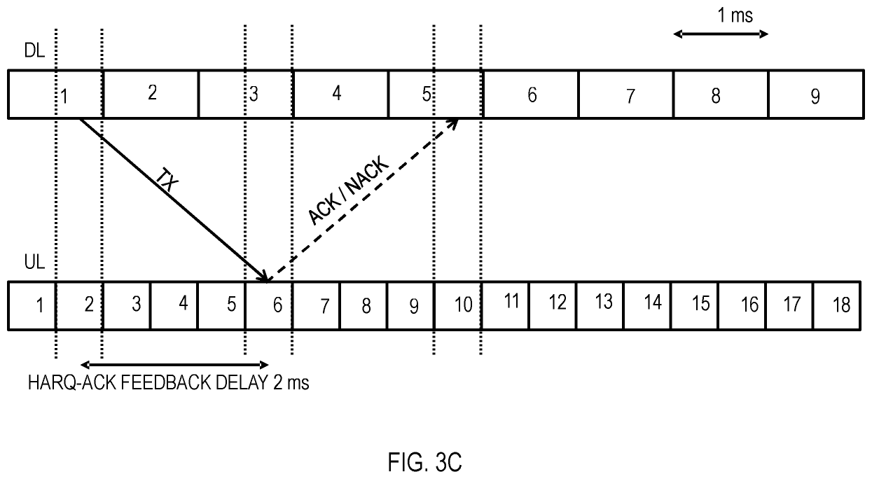

FIG. 3A shows this mode. As can be seen, the acknowledgment delay (i.e. HARQ-ACK delay) is 4 ms which corresponds to 4 subframes. The eNB 110 may send the DL data in TTI #1 and the UE 120 sends the HARQ-ACK (either ACK or NACK) in TTI #5 due to the 4 TTI (=4 ms) processing delay. The eNB 110 may re-send the data (in case of NACK) earliest in TTI #9. In this type of legacy operation, one TTI corresponds to one subframe.

In an embodiment, the first mode (i.e. the fall-back mode) is selected when the TTI, used in the transmission of the scheduled data, is of a predetermined length. As shown, in this mode, the HARQ-ACK also applies a TTI of the predetermined length. The former may be called DL TTI and the latter may be called UL TTI. The predetermined length may be the legacy TTI, e.g. 1 ms, as a non-limiting example.

A second mode may be called a short TTI mode. In this mode, the TTIs for DL transport blocks carrying the DL data to the UE 120 have a shortened duration of e.g. 1, 2, 3, 4, 5 or 6/7 OFDM-symbols (as opposed to 12/14 symbols in a full 1 ms TTI). Correspondingly, the PUCCH duration (TTI) for the HARQ-ACK is also scaled so that a sTTI is applied for the HARQ-ACK transmission. In one embodiment, the duration of the sTTI for HARQ-ACK is selected to be the same as that of the DL transport block(s). In one embodiment, the HARQ-ACK feedback delay is preferably also reduced linearly, i.e. feedback for DL sTTI # n is transmitted in the UL sTTI # n+4, or later. Another option is to define it in a generic way as # n+k, or later, where k is a predetermined processing delay. This reduces complexity in the system design, as the same 4 TTIs HARQ-ACK processing delay is maintained.

FIG. 3B shows this mode. As can be seen, the acknowledgment delay (i.e. HARQ-ACK delay) is only 2 ms. Note that this example assumes the sTTI has a duration of 0.5 ms. This is merely a non-limiting example and other values may be useable as well. With sTTI=2OFDM symbols, the HARQ-ACK delay may be 4*2 symbols=8 symbols, assuming the same 4 TTIs HARQ-ACK processing delay is maintained. The eNB 110 may send the DL data in sTTI #1 and the UE 120 sends the HARQ-ACK (either ACK or NACK) in sTTI #5 due to the 4 sTTI (=2 ms) processing delay. The eNB 110 may re-send the data (in case of NACK) earliest in sTTI #9, and so on. As seem, sTTI helps in reducing latency.

In an embodiment, the second mode (i.e. the short TTI mode) is selected when the TTI, used in the transmission of the scheduled data, is shorter than the predetermined length, e.g. shorter than 1 ms. In this mode the HARQ-ACK also applies a TTI shorter than the predetermined length, e.g. shorter than 1 ms legacy TTI. In one embodiment, the DL TTI and the UL TTI are of the same length. This may provide efficiency in UL-DL synchronization. However, in another embodiment, the DL TTI and the UL TTI are of different lengths, which may provide advantages for flexibility of data transfer.

A third mode may be called a fast feedback mode. In this mode, the DL transport blocks carrying the DL data to the UE 120 may be transmitted using the TTI of the legacy operation (e.g. TTI may be 1 ms). However, for the feedback purposes, a shortened TTI is applied for the feedback channel (e.g. PUCCH). In one embodiment, the HARQ-ACK feedback delay is preferably also reduced linearly, i.e. feedback for DL TTI # n (e.g. PDSCH ending with TTI # n, counted in sTTI) is transmitted in the UL k, e.g. k=4 four or more sTTIs later taking the faster processing capabilities of eNB and UE for shorter TTI operation into account. Again “more” may refer to the TDD mode of operation.

FIG. 3C shows this mode. As can be seen the acknowledgment delay (i.e. HARQ-ACK delay) is again only 2 ms. Note that this example assumes the sTTI has a duration of 0.5 ms. This is merely a non-limiting example and other values may be useable as well. In this mode, the UE 120 may use the sTTI for the PUCCH also for legacy DL transport blocks. The eNB 110 may send the DL data in sTTI #2 (looking from the UE point of view) and the UE 120 sends the HARQ-ACK (either ACK or NACK) in sTTI #6 due to the 4 sTTI (=2 ms) processing delay. The eNB 110 may re-send the data (in case of NACK) in sTTI #10, and so on. This helps in reducing latency with minimal complexity at the eNB 110 side.

In an embodiment, the third mode (i.e. the fast feedback mode) is selected when the TTI used in the transmission of the scheduled data is of the predetermined length. However, in this mode the UE 120 applies for the HARQ-ACK a TTI which is shorter than the predetermined length (i.e. the UE 120 applies sTTI for the ACK/NACK transmission process). The predetermined length may be e.g. 1 ms, as a non-limiting example. The sTTI used for the HARQ-ACK may be e.g. one of 1, 2, . . . , or 6/7 symbols. This may provide fast feedback with low eNB complexity.

Table below shows the different modes and related acknowledgment feedback timings. Note that 1 ms as the legacy TTI length is simply an example and other value is possible as well, depending on the specification for the underlying communication scenario.

| | DL | UL (PUCCH) | HARQ-ACK |
|---|---|---|---|
| | TTI length | TTI length | delay |
| Fall- | 1 ms | 1 ms | HARQ-Ack is trans- |
| back | | | mitted 4 TTIs |
| mode | | | (4 ms) later |
| Short | Less than 1 ms | Less than 1 ms | HARQ-Ack is trans- |
| TTI | (e.g. 1, 2, 3, 4, | (e.g. 1, 2, 3, 4, | mitted 4 sTTIs |
| mode | or 7 OFDM- | or 7 OFDM-sym- | (<=2 ms) later |
| | symbols) | bols), possibly the | |
| | | same as the DL TTI | |
| | | length | |
| Fast | 1 ms | Less than 1 ms | HARQ-Ack is trans- |
| feedback | | (e.g. 1, 2, 3, 4, | mitted 4 sTTIs |
| mode | | or 7 OFDM-symbols) | (<=2 ms) later |

As can be seen from above, the selected acknowledgement feedback mode defines the ACK/NACK timing and the to-be-applied TTI for the channel (e.g. PUCCH) in which the acknowledgement feedback (ACK/NACK) is sent to the eNB 110. In an embodiment, the timing of the first mode applies a longer transmission time interval for sending the acknowledgement feedback to the transmitter than the second and third modes.

The selection of the TTI also affects the processing delay for the ACK/NACK signalling. Let us consider one example of 1 ms TTI vs. a slot level (0.5 ms) TTIs here. For the legacy operation, the UE 120 has 4 ms time to 1) decode the DL grant from PDCCH/EPDCCH, 2) perform channel estimation if DMRS based TM used, 3) decode the PDSCH with a maximum of TBS, 4) create the ACK/NACK feedback on PUCCH for transmission, and 5) start the ACK/NACK transmission. In contrast, having a slot level TTI, the UE 120 equally needs to do the following, but has only 2 ms time after the end of the DL subframe to do the same steps. One difference may be the double TBS size (i.e. a 1 ms TTI contains about double the amount of Turbo-code blocks compare to the slot level TTI), but this would at maximum introduce an additional delay of 1 slot when comparing 1 ms TTI and slot level TTI.

In an embodiment, the TTI of the HARQ-ACK in at least one of the HAR-ACK modes is different than the TTI used in the transmission of the scheduled data. E.g. when looking at the fast feedback mode, the DL TTI is the legacy TTI whereas the UL TTI is a sTTI. Another mode might be that the eNB and UE use sTTI e.g. for the PDSCH (or other downlink channel), and the legacy TTI for PUCCH (or other uplink channel). Such mode may be used if the UL coverage needs to be improved.

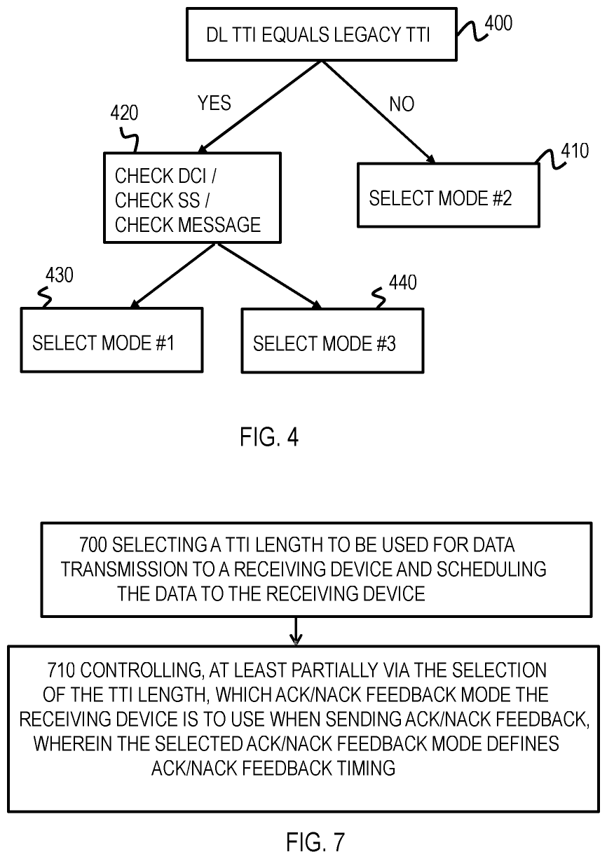

Let us next take a look at the mode selection via a flow diagram depicted in FIG. 4. As disclosed above, one criterion for selecting the mode, and consequently, the HARQ-ACK timing and the length of the TTI, is the TTI used in the DL data transmission to the UE 120. The UE 120 may check in block 400 whether the DL TTI equals the legacy TTI. If the answer is yes, the UE 120 may select the first or the third mode. This will be described in more details below. On the other hand, when the DL TTI does not equal to the legacy TTI, e.g. sTTI (i.e. something shorter than the legacy TTI) is used, the UE 120 may select the second mode in block 410. In other words, the second mode (short TTI mode) may be used whenever shortened DL PDSCH transport blocks are scheduled to the UE 120. In an embodiment, the DL scheduling for sTTI is done via a shortened sPDCCH or a shortened evolved PDCCH (sEPDCCH). The DL scheduling may contain a specific downlink control information format. Although it is assumed that the DL TTI not equaling with the legacy TTI in block 400 means that sTTI is used in DL, it may also happen that the applied TTI is longer than the legacy TTI. This may help in coverage issues. In such case, the UE 120 may also adapt a longer TTI to be used for the feedback signalling.

However, there may be further criteria as well, as depicted with block 420. The further criteria may be used to instruct the UE 120 to select between the first (in block 430) and the third mode (in block 440), for example. Let us look at these further criteria.

In an embodiment, the selection of the acknowledgement feedback mode is further based on control information format used for scheduling the data to the receiving device. The control information may be e.g. downlink control information, DCI. In one embodiment, the DCI format may be used in the selection so that the first mode (fall-back mode) is selected when a first control information format is used and the third mode (fast feedback mode) is selected when a second control information format is used. In an embodiment, the first control information format may be e.g. DCI format 1A and the second control information mode may be any other downlink control information format than the DCI format 1A to schedule PDSCH. The DCI format 1A is used here as merely one example, it is non-limiting, and other formats may be used instead. Alternatively a set of control information formats may belong to the first control information format and a different set of other control information formats may belong to the second control information format.

In an embodiment, the selection of the acknowledgement feedback mode is further based on a type of control channel used for scheduling the data to the receiving device. For example, data transmission with a sTTI may be scheduled with a different control channel, such as sPDCCH or sPDSCH, than the legacy TTI data transmission. As an example, the selection of the TTI length for a first slot may be in the first slot based on the DCI content. However, in a 2^{nd} slot, the selection may be based on the type of the control channel used for scheduling in the second slot (e.g. sPDCCH or sEPDCCH, instead of PDCCH or ePDCCH).

In an embodiment, the selection of the HARQ-ACK mode is further based on a defined search space (SS) for the control information used for scheduling the data to the UE 120. E.g. the first mode is selected when the when PDCCH common search space (CSS) is used for scheduling, whereas the third mode is used when the scheduling is done using UE specific search space (USS).

In this way the fall-back mode may be applied when a specific control channel, search space and a DCI format is used for scheduling the DL data to the UE 120. In one embodiment, the fall-back mode is applied when the scheduling is done using the DCI format 1A and/or when PDCCH common search space is used for scheduling. The fast feedback mode may be used when a specific (e.g. legacy TTI) control channel (e.g. PDCCH), search space and a DCI format is used for scheduling. In one embodiment, the fast feedback mode is applied when the scheduling is done using a UE specific search space (USS), and/or when the DCI format other than 1A is used for scheduling, and the DCI is carried on the legacy (e.g. 1 ms TTI) control channel.

In yet one embodiment, the selection of the acknowledgement feedback mode is further based on an indication from the eNB 110 regarding which acknowledgement feedback mode the UE 120 is to use. For example, the DCI may include a specific bit or information element indicating whether the HARQ-feedback should follow the legacy timeline (i.e. the fall-back mode), or a shorter timeline (i.e. the fast feedback mode).

Accordingly, there is also proposed a dynamic switching between the aforementioned modes. A prerequisite may be that the UE has been configured to operate in latency reduction mode, including e.g. UL and DL control channel resources etc. In one embodiment, the UE 120 may dynamically adjust the TTI length of the channel in which the acknowledgement feedback is sent based on configuration from the eNB 110. Such adjustment may be needed in case the to-be-used ACK/NACK timing is different than current ACK/NACK timing. E.g. the UE 120 may currently operate for PUCCH with legacy TTIs. However, detecting that the eNB 110 schedules data to the UE 120 with sTTIs, the UE 120 may follow the eNB's configuration/scheduling operation and switch to short TTI mode and consequently start using short TTIs for the ACK/NACK signalling on PUCCH. Once the ACK/NACK is sent to the eNB, the UE 120 may either continue using the short TTI mode or return to using legacy TTIs. For the next scheduled DL data, the UE 120 may make a new determination about the to-be-applied TTI length for the ACK/NACK signalling on PUCCH for this scheduled data.

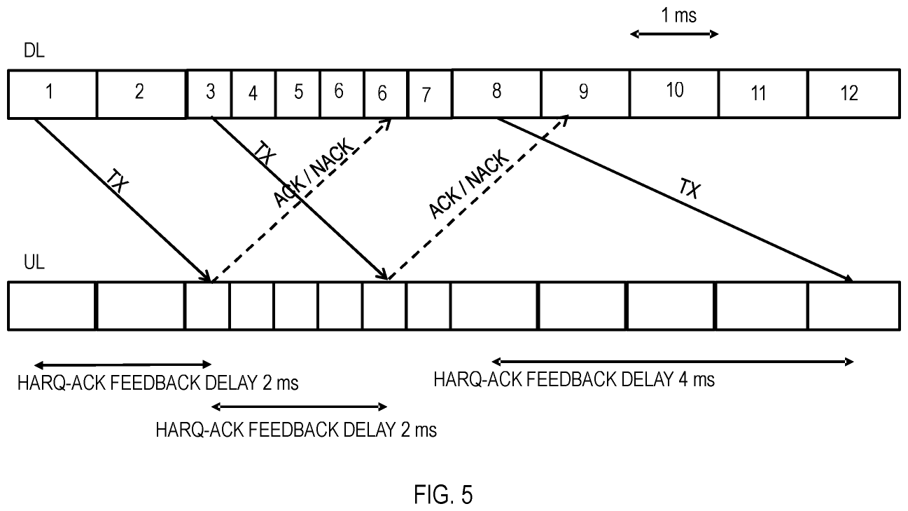

The dynamic switching and control of the modes may therefore rest at the eNB 110. The eNB 110 may control the switching by controlling the characteristics of the data scheduling to the UE 120. An example of dynamic switching is shown in FIG. 5. There the eNB 110 schedules in TTI #1 data to the UE 120 using a legacy TTI. However, the DCI format is something else than 1A, so the UE 120 may decide to use fast feedback mode and process the HARQ ACK in 2 ms (assuming the sTTI here is 0.5 ms and that the processing delay is fixed to 4 TTIs). The other DL data scheduled in TTI #3 is scheduled using the sTTI, so the UE 120 will also use sTTI in the HARQ-ACK processing. The third data scheduled in TTI #8 is scheduled using the legacy TTI and DCI format 1A. Thus, the UE 120 may decide to follow the fall-back mode for the HARQ-ACK processing. Here the HARQ-ACK delay may be e.g. 4 ms. Therefore, there may be a smooth fallback operation provided as well. For other scheduled DL formats (e.g. with DCI formats 2x), the new fast feedback mode may apply. Thus, the invention provides smooth transition between the modes. In order to prevent the need to have both PUCCHs (legacy and sTTI) active at the same time, some prioritization may take place (e.g. legacy PUCCH having higher priority) or this is left to eNB implementation, e.g. by scheduling later scheduled DL only with DCI format other than Format 1A to cause the UE 120 to select the fast feedback mode.

As can be seen, the eNB 110 may decide whether to schedule DL with sTTIs or legacy TTIs on a subframe basis. This may enable the eNB 110 to dynamically and smoothly switch between modes without complicated HARQ-ACK feedback mapping to PUCCH.

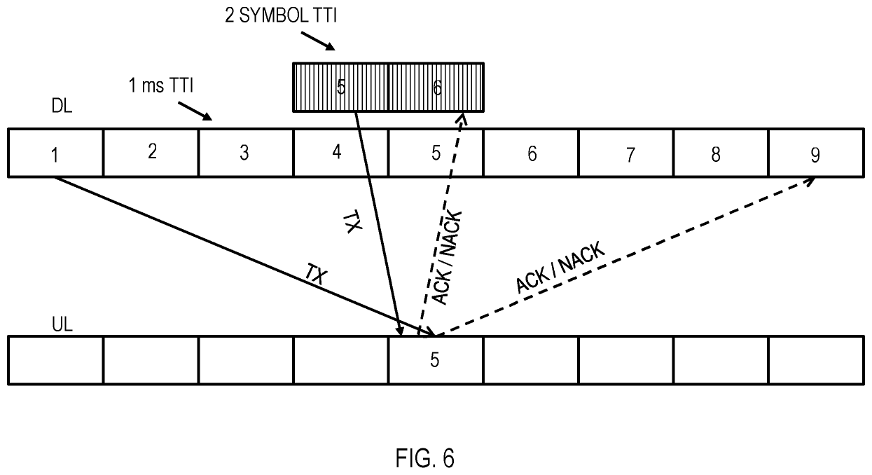

In some cases it may occur that the lower HARQ-ACK feedback latency with sTTIs might cause that UL ACK/NACKs may collide, as shown in FIG. 6. The FIG. 6 shows a timing relation of the HARQ feedback in the presence of DL transmissions with different TTI lengths. The figure assumes FDD frame structure, scaling of the feedback latency linearly according to the TTI length, and 8 HARQ processes both for 1-ms and 2-symbol TTIs. Thus, let us assume a PDSCH with legacy TTI and a PDSCH with shortened TTI (e.g. of 2 OFDM symbols) which are transmitted in different DL subframes. Here it is assumed that DL with legacy TTI is transmitted in subframe #1 and the DL with sTTI is transmitted in subframe #4. As a consequence, the ACK/NACK for the sTTI DL data is to be sent in subframe #5. Also the ACK/NACK for the legacy TTI DL data is to be transmitted in subframe #5. Thus, depending on which subframes the DL data are transmitted, the corresponding HARQ-ACK feedback might initially need to be transmitted simultaneously in the same subframe.

To avoid such ACK/NACK collisions, in an embodiment, the UE 120 may receive a message from the eNB 110. The message may instruct the UE 120 to delay a specific acknowledgement feedback transmission. The specific HARQ-ACK transmission may refer to the HARQ-ACK using sTTIs. As one example implementation, the DCI may include a specific bit or information element indicating whether the HARQ-feedback should be delayed by one or more sTTIs compared to minimum timing (e.g. in order to avoid collisions between sTTI PUCCH and 1-ms PUCCH/PUSCH in UL). E.g. the minimum timing may be given by N+4. This may mean that if mode 2 or mode 3 is scheduled later than the fallback mode, that the ACK/NACK feedback should be delayed till later than N+4 (e.g. N+6 if so instructed in the DCI). It should be noted that the vertical filling in the blocks does not depict OFDM symbols within the subframe, but is to reflect that shortened TTI is used in those subframes for scheduling and DL data.

From the eNB 110 (or in general, transmitting device's) point of view, the proposal may include, as shown in FIG. 7, selecting (block 700) the TTI length to be used for data transmission to the UE 120 and scheduling the data to the UE 120. The eNB 110 may in this way control (block 710) which acknowledgement feedback mode amongst a plurality of acknowledgement feedback modes the UE 120 will use for the HARQ-ACK feedback regarding the scheduled data.

It needs to be noted that the eNB 110 using legacy TTI and the UE 120 using sTTI, such as in the fast feedback mode, means that the eNB 110 uses legacy TTI for the DL transmission and the sTTI for the corresponding ACK/NACK reception in UL, and that the UE 120 uses legacy TTI for the DL reception and sTTI for the corresponding ACK/NACK signalling in UL. Therefore, the eNB 110 is in control of which mode is to be used in which direction, and the eNB 110 and the UE 120 have common understanding of the to-be-applied mode in both directions.

Some advantages of the proposal may include that e.g. multiplexing of HARQACK corresponding to legacy TTI and sTTI is smooth and fully under eNB's control, there is reduced (or no) need for simultaneous transmission of legacy PUCCH and sTTI PUCCH, achieving “5G-like” latency performance on top of evolutionary LTE-Advanced Pro system, and/or the PUCCH coverage may be optimized. Regarding the latency reductions, some example simulations have shown that a one-way delay of 4.8 ms may be improved to 2.4 ms with a 1-slot sTTI and to 0.69 ms with a 2-symbol sTTI. Further, in one example embodiment, applying the 1-slot sTTI in UL&DL combined with 2-symbol sTTI processing times, the total one-way delay may be 1.31 ms, whereas applying the 1-ms legacy TTI in UL&DL combined with 1-slot sTTI processing times, the total one-way delay may be 3.35 ms. Thus, clearly significant delay reductions may be obtained with the solution. The solution is also attractive from the eNB implementation point of view as latency may be improved with minimized UL impact (including UL coverage) and because dynamic switching of DL TTI length is supported without affecting HARQ-ACK feedback delay or the number of HARQ-ACK bits carried on single PUCCH sTTI. This may lead e.g. to less error cases (e.g. due to missed DL grant) to cover on PUCCH detection. The proposal may offer reduced need for prioritization rules e.g. between legacy PUCCH and sTTI PUCCH and less complex rules for power control (reduced need for simultaneous transmission).

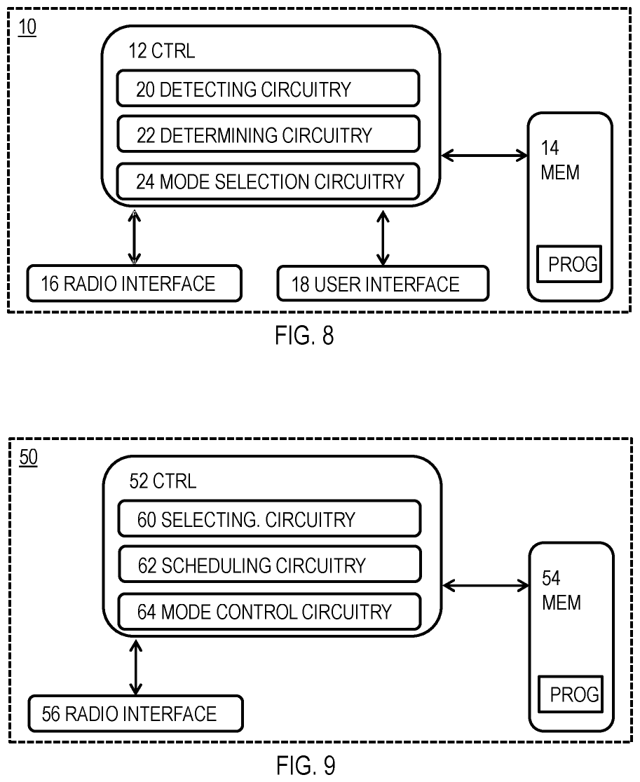

An embodiment, as shown in FIG. 8, provides an apparatus 10 comprising a control circuitry (CTRL) 12, such as at least one processor, and at least one memory 14 including a computer program code (PROG), wherein the at least one memory and the computer program code (PROG), are configured, with the at least one processor, to cause the apparatus to carry out any one of the above-described processes. The memory may be implemented using any suitable data storage technology, such as semiconductor based memory devices, flash memory, magnetic memory devices and systems, optical memory devices and systems, fixed memory and removable memory.

In an embodiment, the apparatus 10 may comprise the terminal device of a cellular communication system, e.g. a user equipment (UE), a user terminal (UT), a computer (PC), a laptop, a tabloid computer, a cellular phone, a mobile phone, a communicator, a smart phone, a palm computer, or any other communication apparatus. Alternatively, the apparatus 10 is comprised in such a terminal device. Further, the apparatus 10 may be or comprise a module (to be attached to the UE) providing connectivity, such as a plug-in unit, an “USB dongle”, or any other kind of unit. The unit may be installed either inside the UE or attached to the UE with a connector or even wirelessly. In an embodiment the apparatus is or is comprised in the UE 120.

The apparatus 10 may further comprise communication interface (TRX) 16 comprising hardware and/or software for realizing communication connectivity according to one or more communication protocols. The TRX may provide the apparatus with communication capabilities to access the radio access network, for example.

The apparatus 10 may also comprise a user interface 18 comprising, for example, at least one keypad, a microphone, a touch display, a display, a speaker, etc. The user interface X may be used to control the apparatus by the user.

The control circuitry 10 may comprise a detection circuitry 20 for detecting that DL data is scheduled to the apparatus 10, according to any of the embodiments. The control circuitry 10 may comprise a determination circuitry 22 for determining the TTI length of the scheduled data, according to any of the embodiments. The control circuitry 10 may comprise a mode selection circuitry 24 for selecting the acknowledgement feedback mode, according to any of the embodiments.

An embodiment, as shown in FIG. 9, provides an apparatus 50 comprising a control circuitry (CTRL) 52, such as at least one processor, and at least one memory 54 including a computer program code (PROG), wherein the at least one memory and the computer program code (PROG), are configured, with the at least one processor, to cause the apparatus to carry out any one of the above-described processes. The memory may be implemented using any suitable data storage technology, such as semiconductor based memory devices, flash memory, magnetic memory devices and systems, optical memory devices and systems, fixed memory and removable memory.

In an embodiment, the apparatus 50 may be or be comprised in a base station (also called a base transceiver station, a Node B, a radio network controller, or an evolved Node B, for example). In an embodiment the apparatus is or is comprised in the eNB 110.

The apparatus 50 may further comprise communication interface (TRX) 56 comprising hardware and/or software for realizing communication connectivity according to one or more communication protocols. The TRX may provide the apparatus with communication capabilities to access the radio access network, for example.

The control circuitry 52 may comprise a selection circuitry 60 for selecting the TTI length for data transmission, according to any of the embodiments. The control circuitry may comprise a scheduling circuitry 62 for scheduling one or more UEs with data transmission, according to any of the embodiments. The control circuitry 10 may comprise a mode control circuitry 64 for controlling the selection of the acknowledgement feedback mode, according to any of the embodiments.

In an embodiment at least some of the functionalities of the apparatus of FIG. 9 may be shared between two physically separate devices forming one operational entity. Therefore, the apparatus may be seen to depict the operational entity comprising one or more physically separate devices for executing at least some of the described processes. The apparatus utilizing such shared architecture, may comprise a remote control unit (RCU), such as a host computer or a server computer, operatively coupled (e.g. via a wireless or wired network) to a remote radio head (RRH) located in the base station. In an embodiment, at least some of the described processes may be performed by the RCU. In an embodiment, the execution of at least some of the described processes may be shared among the RRH and the RCU.

In an embodiment, the RCU may generate a virtual network through which the RCU communicates with the RRH. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (i.e. to the RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between the RRH and the RCU. In practice, any digital signal processing task may be performed in either the RRH or the RCU and the boundary where the responsibility is shifted between the RRH and the RCU may be selected according to implementation.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1-23. (canceled)

24. An apparatus, comprising:
at least one processor and at least one memory including a computer program code, wherein the at least one memory and the computer program code are configured, with the at least one processor, to cause the apparatus to perform:
detect that data from a transmitting device is scheduled to the apparatus;
determine a transmission time interval length applied in the transmission of the scheduled data to the apparatus;
select an acknowledgement feedback mode to be used for sending acknowledgment feedback for the scheduled data amongst a plurality of acknowledgement feedback modes;
wherein
the selection is based on the determined transmission time interval length and further based on at least one of: a control information format used for scheduling the data to the apparatus, a type of a control channel used for scheduling the data to the apparatus or a defined search space of the control information used for scheduling the data to the apparatus;
wherein
the selected acknowledgement feedback mode defines a transmission time interval length for a channel in which the acknowledgement feedback is sent to the transmitting device; and
transmit the acknowledgement feedback to the transmitting device in accordance with the selected acknowledgement feedback mode.

25. The apparatus of claim 24, wherein the at least one memory and the computer program code are configured, with the at least one processor, to cause the apparatus to perform:
dynamically adjust the transmission time interval length of the channel in which the acknowledgement feedback is sent to the transmitting device.

26. The apparatus of claim 24, wherein the transmission time interval length of the acknowledgement feedback transmission in at least one of the plurality of acknowledgement feedback modes is different than the transmission time interval length used in the transmission of the scheduled data.

27. The apparatus of claim 24, wherein the at least one memory and the computer program code are configured, with the at least one processor, to cause the apparatus to perform:
select a first acknowledgement feedback mode when the transmission time interval used in the transmission of the scheduled data is of a predetermined length, wherein the acknowledgement feedback applies a transmission time interval of the predetermined length in the first acknowledgement feedback mode.

28. The apparatus of claim 24, wherein the at least one memory and the computer program code are configured, with the at least one processor, to cause the apparatus to perform:
select a second acknowledgement feedback mode when the transmission time interval used in the transmission of the scheduled data is shorter than a predetermined length, wherein the acknowledgement feedback applies a transmission time interval shorter than the predetermined length in the second acknowledgement feedback mode.

29. The apparatus of claim 24, wherein the at least one memory and the computer program code are configured, with the at least one processor, to cause the apparatus to perform:
select a third acknowledgement feedback mode when the transmission time interval used in the transmission of the scheduled data is of a predetermined length, wherein the acknowledgement feedback applies a transmission time interval shorter than the predetermined length in the third acknowledgement feedback mode.

30. The apparatus of claim 29, wherein the predetermined length of the transmission time interval corresponds to one subframe.

31. The apparatus of claim 24, wherein the selection of the acknowledgement feedback mode is further based on an indication from the transmitting device regarding which acknowledgement feedback mode the apparatus is to use.

32. The apparatus of claim 24, wherein the at least one memory and the computer program code are configured, with the at least one processor, to cause the apparatus to perform:
receive a message from the transmitting device, the message instructing the apparatus to delay a specific acknowledgement feedback transmission.

33. The apparatus of claim 24, wherein the apparatus is a user equipment.

34. An apparatus, comprising:
at least one processor and at least one memory including a computer program code, wherein the at least one memory and the computer program code are configured, with the at least one processor, to cause the apparatus to perform:
schedule data to a receiving device;
select a transmission time interval length to be used for transmitting the scheduled data to the receiving device;
transmit the scheduled data to the receiving device in accordance with the selected transmission time interval length;
control which acknowledgement feedback mode amongst a plurality of acknowledgement feedback modes the receiving device is to use when sending acknowledgment feedback for the transmitted data to the apparatus;
wherein
the controlling is based on the selected transmission time interval length for the scheduled data and further based on at least one of: a control information format used for scheduling the data to the receiving device, a type of a control channel used for scheduling the data to the receiving device, or a defined search space of the control information used for scheduling the data to the receiving device;
wherein
the selected acknowledgement feedback mode defines a transmission time interval length for a channel in which the acknowledgement feedback is sent from the receiving device; and
receive the acknowledgement feedback from the receiving device in accordance with the acknowledgement feedback mode.

35. The apparatus of claim 34, wherein the transmission time interval length of the acknowledgement feedback transmission in at least one of the plurality of acknowledgement feedback modes is different than the transmission time interval length used in the transmission of the scheduled data.

36. The apparatus of claim 34, wherein the controlling causes the receiving device to:
select a first acknowledgement feedback mode when the transmission time interval used in the transmission of the scheduled data is of a predetermined length, wherein the acknowledgement feedback applies a transmission time interval of the predetermined length in the first acknowledgement feedback mode.

37. The apparatus of claim 34, wherein the controlling causes the receiving device to:
select a second acknowledgement feedback mode when the transmission time interval used in the transmission of the scheduled data is shorter than a predetermined length, wherein the acknowledgement feedback applies a transmission time interval shorter than the predetermined length in the second acknowledgement feedback mode.

38. The apparatus of claim 34, wherein the controlling causes the receiving device to:
select a third acknowledgement feedback mode when the transmission time interval used in the transmission of the scheduled data is of a predetermined length, wherein the acknowledgement feedback applies a transmission time interval shorter than the predetermined length in the third acknowledgement feedback mode.

39. The apparatus of claim 38, wherein the predetermined length of the transmission time interval corresponds to one subframe.

40. The apparatus of claim 34, wherein the controlling which acknowledgement feedback mode the receiving device is to use is further based on the apparatus indicating which acknowledgement feedback mode the receiving device is to use.

41. The apparatus of claim 34, wherein the at least one memory and the computer program code are configured, with the at least one processor, to cause the apparatus to perform:
transmit a message to the receiving device, the message instructing the receiving device to delay a specific acknowledgement feedback transmission.

42. A method, comprising:
detecting, by a receiving device, that data from a transmitting device is scheduled to the receiving device;
determining a transmission time interval length applied in the transmission of the scheduled data to the receiving device;
selecting an acknowledgement feedback mode to be used for sending acknowledgment feedback for the scheduled data amongst a plurality of acknowledgement feedback modes;
wherein
the selecting is based on the determined transmission time interval length and further based on at least one of: a control information format used for scheduling the data to the apparatus, a type of a control channel used for scheduling the data to the apparatus or a defined search space of the control information used for scheduling the data to the apparatus;
wherein
the selected acknowledgement feedback mode defines a transmission time interval length for a channel in which the acknowledgement feedback is sent to the transmitting device; and
transmitting the acknowledgement feedback to the transmitting device in accordance with the selected acknowledgement feedback mode.

43. The method of claim 42, further comprising at least one of:
selecting a first acknowledgement feedback mode when the transmission time interval used in the transmission of the scheduled data is of a predetermined length, wherein the acknowledgement feedback applies a transmission time interval of the predetermined length in the first acknowledgement feedback mode;
selecting a second acknowledgement feedback mode when the transmission time interval used in the transmission of the scheduled data is shorter than a predetermined length, wherein the acknowledgement feedback applies a transmission time interval shorter than the predetermined length in the second acknowledgement feedback mode; or
selecting a third acknowledgement feedback mode when the transmission time interval used in the transmission of the scheduled data is of a predetermined length, wherein the acknowledgement feedback applies a transmission time interval shorter than the predetermined length in the third acknowledgement feedback mode.
